(19) United States
(12) Patent Application Publication
(10) Pub. No.: US 2010/0268663 A1
(43) Pub. Date: Oct. 21, 2010

(54) SYSTEM AND METHOD FOR TRADING IMPROVED FINANCIAL INSTRUMENTS

(75) Inventor: Hans Torsten ASPLUND, Taby (SE)

Correspondence Address: NIXON & VANDERHYE, PC, 901 NORTH GLEBE ROAD, 11TH FLOOR, ARLINGTON, VA, 22203, US

(73) Assignee: OMX TECHNOLOGY AB, Stockholm (SE)

(21) Appl. No.: 12/423,888

(22) Filed: Apr. 15, 2009

(51) Int. Cl. G06Q 40/00

(52) U.S. Cl. 705/36 R; 705/35; 705/37

(57) ABSTRACT

A computerized exchange system and computerized clearing system for matching and clearing of an improved financial instrument. The financial instruments being associated with central bank interest rates and may be used, among other things, to facilitate understanding of the price of an interest rate that is based on the central banks interest rate.

### FIELD OF THE INVENTION

The present invention relates to an improved financial instrument and to a computer system and computer implemented method for trading of the improved financial instrument as well as to a computer system for clearing and settlement of the improved financial instrument.

### BACKGROUND OF THE INVENTION

In late 2008 and early 2009 the financial industry was under heavy pressure due to a number of reasons that resulted in a global crisis known as the financial crisis. When such crises occur banks usually have a central role with regards to policies, in particular relating to interest rates. For example Central Banks are conducting their monetary policy regimes by either lending or borrowing money to/from their counterparties and buy doing so they control short term money market rates through changes in supply of money/funds. Short term interest rates, such as interest rates of debts of maximum 1 year (for example USD-, EURO-; GBP-; JPY-; SEK denominated debts, etc) all derives from central bank monetary policy rates. However when a money market transaction takes place, for example a money borrowing or lending transaction, between two parties of which none is a central bank or a government entity, there is a credit risk associated with the transaction. The price/interest rate of the transaction should always reflect that credit risk. In known systems the credit risk is transformed into an extra interest rate cost added to the central bank interest rate for the corresponding period. This is also the case for the heavily used and highly liquid short term interest rate futures and similar instruments such as SEK Forward Rate Agreements (FRA), NOK Forward Rate Agreements, Euro Dollar Futures, EURIBOR Futures and so forth. These instruments are examples of main instruments for managing short term interest rate risk.

When these FRA/futures contracts are based on interbank lending rates, the price of the FRA/futures reflects future credit risk spreads combined with future central bank interest rates, however it is not clear how much of the price is represented by credit risk costs or central bank interest rates. In extra ordinary times, such as in late 2008, disturbances in the credit markets led to higher interbank interest rates in a market environment where lower central bank rates were in overall expected. These expectations could not be profit from when interbank interest rates where increasing in an abnormal way.

Furthermore, central banks have well defined objectives and inflation/money supply is often the key objective. In order to achieve the inflation objective central banks uses the monetary policy as an important tool. When deciding on the monetary policy one important component underlying the decision, is the markets view on future central bank interest rates. At the moment there exist no good sources for this kind of information. Central banks instead use money market interest rates on various futures, swap, and spot market contracts and tries to derive expectation of future central bank interest rates which to some extent must be a guessing game. How the market price future credit risk spreads, are also of interest not only for central bankers but also for lenders and borrowers in the money markets.

A solution to some of the above mentioned drawbacks is disclosed in the fact sheet “New Zealand 30 Day Official Cash Rate Futures”. This fact sheet discloses “Sydney Futures Exchange's New Zealand 30 day official cash rate futures contract, based on the reserve bank of New Zealand's target official cash rate, enables users with New Zealand interest rate exposure to better manage their daily cash exposures and hedge against changes in the New Zealand official cash rate”. Even though it is a good solution it has a number of drawbacks. For example the value calculated can not mirror a transaction series that is close to reality. Furthermore the end fixing of the futures does not replicate an exact cost. The underlying interest rate period is not equal to the three month time period between two IMM dates, which in several major money markets is the most liquid segment, e.g. USD, EUR and SEK. Therefore the prior art instruments and system are restricted in their use.

### BRIEF DESCRIPTION OF THE INVENTION

Thus it is an object of the present invention to provide a financial instrument that provides more accurate information.

It is another object of the present invention to provide an improved futures contract.

It is another object of the present invention to provide a futures contract that is more flexible compared to state of the art futures contracts.

It is another object of the present invention to provide a computer system for trading improved futures contracts.

It is another object of the present invention to provide a clearing system for clearing of improved futures contracts.

It is another object of the present invention to provide a futures contract that is based on real-time information from a bank.

It is a further object of the present invention to prove a solution for market participants who wish to enter into an exposure to changes in central bank interest rates without having to be exposed to credit risk costs or change in credit risk costs or interbank lending rates.

It is even a further object of the present invention to provide central banks, and others, with accurate information of the markets view of future central bank interest rates.

It is a further object of the present invention to provide transparency about future interbank credit risk costs.

It is a further object of the present invention to enable spread trading between interbank rates and central bank rates.

According to a first aspect of the invention the above and other objects are is achieved by providing a financial instrument stored in a memory of a computer system, the financial instrument comprising: attributes defining a time period comprising a start time and an end time, and attributes defining one or more sub periods between the start time and the end time of the time period, wherein a final value of the financial instrument is based on an aggregation of central bank interest rates associated with one or more of the one or more sub periods.

The above financial instrument has the advantage that it will only reflect the markets view on future central bank rates, and that there is no credit risk component in the pricing of the contracts and thereby providing an effective pricing mechanism of the financial instrument. Furthermore it makes the future credit risk cost in the interbank market transparent, and the instrument price will more effectively and more accurate indicate the markets view on the future central bank interest rates. Even further the financial instrument has the advantage that it is based on the aggregation of central bank interest rates and therefore it can provide much more flexible and accurate information. In opposite to other financial instrument this financial instrument constitute a perfect hedge instrument for those banks which are borrowing funds in the central bank on a regular basis.

Preferably the instrument is stored in a computer memory such as in the primary memory for example in the cash memory or similar working memory RAM, DRAM and so forth. However it may also be stored on a hard disc or on a removable memory such as a USB stick accessible by the computer system.

The attribute defining the time period is preferably a memory allocation comprising data defining the time period by a start time and end time. The data could be in the format yyyy.mm.dd or the alike, such as hh.mm.ss or a combination of both. The start date and end date may be the International Money Market (IMM) dates.

The attributes defining the one or more sub periods are also preferably memory allocations comprising data defining the one or more sub periods. Either there could be one attribute for defining all sub periods or a number of attributes each defining its own sub period. Preferably the sub periods are shorter than the time period such that the time period comprises one or more sub periods. The time period could also comprise blocks of sub periods that are of the same length.

Each sub period is preferably associated with a central bank interest rate so that when calculating the final value of the financial instrument, the interest rate associated with the one or more sub periods is aggregated. Thus, the final value may be an aggregation of any number of the interest rate values relating to the sub periods. Such as 2, 3, 5, 6, 7, 8, 10 12, 14, or more sub periods, such as 20, 30 and 40 sub periods. The final value may be an expiration fixing value.

Furthermore in the end or beginning of the time period a sub period may be cut-off such that it ends or starts at the same time as the time period. Therefore the sub periods in the beginning respectively the end of the time period may be shorter compared to the other sub periods within the time period. The sub periods in the beginning respectively the end of the time period could also be longer or the same as the other sub periods.

In a preferred embodiment of the invention the final value is calculated in accordance with.

$$( ( {\prod }_{k = 1}^{n} 1 + \frac{{r}_{k}}{100} * \frac{{d}_{k}}{360} ) - 1 ) * \frac{360}{cd} * 100$$

Where:

r is the central bank interest rate for a specific sub period (k),

d is the number of days for a specific sub period (k),

k is the number of sub periods,

cd is the number of days between the start time and the end time of the time period such as the number of contract days.

The financial instrument may further comprise attributes defining a nominal amount to be used as a base for the financial instrument. Such as a contract base or contract standard. This contract base may be a synthetic 3-month loan where the 3-month period is deemed to correspond to the actual days between two IMM dates and cash and with a standardized nominal amount, settled on expiration settlement day against the average central bank repo rate for the specific period, expressed as compounded rate. Preferably the nominal amount of the contract base is one million SEK, however it could be any amount in any currency that is suitable for the purpose wherein the financial instrument may used.

The financial instrument may further comprise attributes defining a settlement method. Preferably the settlement method is selected from a group of settlement methods, the group comprising: daily settlement, monthly settlement or end of period settlement. Other settlement methods may also be considered and used for settlement of the instrument. Preferably the settlement method comprises daily cash settlement.

The financial instrument preferably comprises an acceptance date for accepting the financial instrument prior to the end time of the time period. At the acceptance date two parties may enter into an agreement in relation to the financial instrument. This acceptance date may occur any time before the end time of the time period. Preferably the acceptance date occurs before the final central bank interest rate is decided for the last sub period.

The sub periods in the financial instrument may comprise any number of days between 1-98 days. Preferably the sub periods comprises 7 or 14 days. Furthermore each sub period may have a specific number of days so that the time period of the financial instrument can be divided into different sub periods having different lengths. The start and end time of the sub periods may be associated with the dissemination of new interest rate information from the central bank, such that the start and end time of the sub periods are synchronised with the dissemination occasions.

The dissemination of interest rate information from the central bank is preferably done by using data messages that can be sent over a network to which different data systems used in relation to the invention can be connected.

Preferably the financial instrument is a new type of futures contract.

In a second aspect of the invention, the above and other objects are fulfilled by a computerised method implemented on a computer for calculating a value of a financial instrument stored in a memory of the computer, the financial instrument comprising: attributes defining a time period comprising a start time and an end time, attributes defining one or more sub periods between the start time and the end time of the time period, the method comprising the steps of:
for each sub period, determining a central bank interest rate,
aggregating the central bank interest rates for each sub period,
   thereby calculating the value of the financial instrument.

The above computerised method has the advantage that it is based on the aggregation of central bank interest rates and therefore it can provide a much more flexible construction compared to prior art financial contracts, furthermore it also provides more accurate information on the markets view of future central bank interest rates. The method is executed on a computer system comprising a processor and memory for storing the instructions that the processor will execute in order to perform the computerised method. Furthermore the computer system is connectable to external systems such as computerised bank systems, computerised exchange systems and so forth in order to receive data messages such as data messages comprising central bank interest rate or data relating to other interest rates.

Preferably the final value is calculated in accordance with:

$$( ( {\prod }_{k = 1}^{n} 1 + \frac{{r}_{k}}{100} * \frac{{d}_{k}}{360} ) - 1 ) * \frac{360}{cd} * 100$$

Where:

r is the central bank interest rate for a specific sub period (k),

d is the number of days for a specific sub period (k),

k is the number of sub periods,

cd is the number of days between the start time and the end time of the time period such as the number of contract days.

Furthermore the computerised method may comprise the steps of:
creating a decision point between the start time and the end time of the time period, and
executing the calculation of the final value at the decision point or any time after the decision point.

Thereby the computerised method is able to identify a point in time after which the calculation of the final value can be executed by a computer such as by a computer in a computerised clearing system or computerised exchange system. Preferably the decision point is after the acceptance date mentioned above.

In the computerised method the central bank interest rates associated with the sub periods before and after the decision point may be used in the calculation of the value.

In a third aspect of the invention, the above and other objects are fulfilled by a computerised exchange system for matching orders for financial instruments sent from trading terminals, the financial instrument comprising attributes defining a time period comprising a start time and an end time, and attributes defining one or more sub periods between the start time and the end time of the time period, the computer system comprising:
an input module for receiving a buy order for the financial instrument from a first party, and for receiving a sell order for the financial instrument from a second party, the buy and sell order comprising at least an instrument value set by the parties,
a matching module associated with the input module for matching the buy order with the sell order for the financial instrument based on the instrument values,
   thereby creating a deal.

The above computerised exchange system has the advantage that it can match financial instruments comprising sub periods and thereby provide a more flexible matching system, furthermore as mentioned above it can also provide more accurate information about the market expectations regarding future Central bank interest rates. Preferably the financial instrument is associated with central bank interest rate as mentioned above. Thus a more accurate picture of the markets expectations about the central banks interest rate can be achieved.

The input module for receiving buy and sell orders comprises computer means both hardware and software such as a memory, a processor and interfaces, in order to be able to receive computer messages comprising the buy and/or sell orders that have been sent from a remote computer system such as a trading terminal or an algorithmic trading machine.

The first party may be a trader that wants to buy the financial instrument and the second party may be a trader that wants to sell the financial instrument. Each party may define an instrument value that is sent in their order messages to the computerized exchange system. The instrument value may thus be a future expectation or speculation of the price for the financial instrument. In a preferred embodiment the instrument value is an estimate or a prediction of an index price value or an interest rate value such as the central bank interest rate at a future date. The instrument value may also be associated with the end date of the financial instrument. Thus in an embodiment the buyer and seller may only have to agree on an instrument value at the end date which they are prepared to trade upon.

The matching module also comprises computer means both hardware and software such as a memory, a processor and interfaces such that it can receive data messages comprising the buy and sell orders, and based on the content of the buy and sell orders and based on matching rules match a buy with a sell order if the instrument value in the buy and sell orders are equal.

The buy order may further comprises a configurable first date and a configurable second date for defining a time period for the instrument in the buy order. Thereby the party that is about to send a buy order for the instrument can amend the instrument by defining new dates for the start time and end time of the time period. This is also applicable to the sell orders wherein the sell order may comprise a configurable first date and a configurable second date for defining a time period for the instrument in the sell order. Thereby it may be possible for the traders to create tailor-made instruments for their specific needs which are traded in orderbooks at the computerized exchange system. These orderbooks may be predefined for these specific tailor-made instruments such that the traders can select from a number of predetermined start and end dates.

Furthermore the computerised exchange system comprises an information dissemination module for reporting the deal in the matching module to a computerised clearing system by sending a deal message over a direct link or over a network. Thereby instant or daily clearing calculations can be executed such that balances on accounts can be calculated. This also makes it possible to calculate margining and collateral for the accounts associated with the financial instrument and the parties trading in this instrument.

As mentioned above the computerised exchange system may further comprise a network connection or a link connectable to a bank for receiving input regarding interest rates. This input is preferably received in real time. However it may also be sent in messages at certain time intervals, such as once a day, twice a day, or once a week. The message may comprise data about interest rates such as central bank interest rates or indexed price values and so forth. Preferably the messages are sent according to the FIX standard.

In a fourth aspect of the invention, the above and other objects are fulfilled by a computerised clearing system for clearing of financial instruments comprising attributes defining a time period comprising a start time and an end time, and attributes defining one or more sub periods between the start time and the end time of the time period, the computerised clearing system is configured to either calculate daily fixing values, or it may receive daily fixing values from other systems or receive manually inputted fixing values, the computerised clearing system comprising:
a first memory allocation comprising an account comprising positions associated with the financial instruments for an account holder,
a second memory allocation for storing daily fixing values received by the computerised clearing system, and
a settlement module for performing settlements of the accounts,
   wherein the computerized clearing system comprises instructions that when executed by a processor performs daily settlements for one or more accounts based on the daily fixing value stored in the second memory allocation.

The above mentioned computerised clearing system has the advantage that it will settle financial instrument that preferably only reflect the markets view on future central bank rates, and that there is no credit risk component in the pricing of the contracts and thereby allowing an effective pricing mechanism of the contract. Furthermore it makes the future credit risk cost in the interbank market transparent, and the contract price will more effectively and more accurate indicate the markets view on the future central bank interest rates. Thereby more accurate calculations of margin and collateral can be achieved.

The daily fixing values may be sent to the computerized clearing system from a computerized exchange system or from any other source able to calculate fixing values, or it may be calculated in the clearing system.

The computerised clearing system further comprises instructions on how the processor shall execute calculation, e.g. the daily fixing value can be based on a midprice in an order driven market. Thus the clearing system receives data messages from computerised exchange systems where instruments are traded on order driven markets. The data messages comprising information about market prices so that the clearing system can calculate a midprice. For example the midprice can be based on the latest trades or based on the latest spread. It can also be based on an average calculated on all trades during the day. Furthermore it may also be based on a historical value stored in a memory, for markets having a low liquidity.

The clearing system preferably comprises a margin module for calculating margin associated with the accounts. Thereby the system can handle counterparty risk such as if a member to the clearing house would default. The margining is automatically calculated for each account or for a number of accounts. The clearing system can automatically send out margin calls if more margin is needed for one or more of the accounts. Margin may be provided both in cash or in securitises such as stocks, options, futures, bank notes and so forth or in any combination of cash and securities. Initial margin may be provided by the members connected to the clearing system, the initial margin may also be provided in cash and/or securities.

The clearing system may also comprise a mark to market module for determining a market value for a position in the account. The mark to market module may perform mark to market calculation in order to determine a value of the margin and collateral provided by the members connected to the clearing system.

Thus the computerized clearing system preferably comprises a calculation module for calculating collateral associated with the accounts. The collateral can also be in the form of cash and/or securities similar to the margin.

In a fifth aspect of the invention, the above and other objects are fulfilled by a computer readable medium comprising program instructions for execution on a computer system that, when executed by a processor, cause the processor to match financial instrument comprising attributes defining a time period between a first point in time and a second point in time, and attributes defining a plurality of sub periods within the time period, wherein a final value of the financial instrument is based on an aggregation of central bank interest rates associated with the sub periods.

In a sixth aspect of the invention, the above and other objects are fulfilled by a computer readable medium comprising program instructions for execution on a computer system that, when executed by a processor, cause the processor to clear financial instrument comprising attributes defining a time period between a first point in time and a second point in time, and attributes defining a plurality of sub periods within the time period, wherein a final value of the financial instrument is based on an aggregation of central bank interest rates associated with the sub periods.

In a seventh aspect of the invention, the above and other objects are fulfilled by a computer program product comprising market data, the market data comprising data associated with the financial instrument according to the invention.

These and other aspects of the invention will be apparent from and elucidated with reference to the embodiments described hereinafter.

### BRIEF DESCRIPTION OF FIGURES

FIG. 1 illustrates an interbank market structure.

FIG. 2 illustrates how interest rates may change over time.

FIG. 3 illustrates an embodiment of the financial instrument according to the invention.

FIG. 4 illustrates a computer device comprising a memory and a CPU.

FIG. 5 illustrates a computerised central exchange system, external trading terminals and a clearing system.

FIG. 6 illustrates a computerised clearing system.

FIG. 7 illustrates an embodiment of the financial instrument.

FIG. 8 illustrates prices for traded future contracts according to the invention.

FIG. 9 illustrates an embodiment of the financial instrument according to the invention.

FIG. 10 illustrates payment flows for margin.

FIG. 11 illustrates an embodiment of the financial instrument according to the invention.

FIG. 12 illustrates an embodiment of the financial instrument according to the invention.

FIG. 13 illustrates a flow chart for a computerised method according to an embodiment of the invention.

FIG. 14 illustrates a flow chart for a computerised method according to an embodiment of the invention.

FIG. 15 illustrates an example of a computer readable medium.

FIG. 16 illustrates two vector files.

FIG. 17 illustrates central banks repo rates during a time period.

### DESCRIPTION OF PREFERRED EMBODIMENTS

According to a preferred embodiment the financial instrument may be a daily cash settled future contract quoted in yield. The daily settlement may be towards the daily series fixing prices based on quotes from market makers and calculated by the exchange or a fixing provider used by the exchange. The final settlement may be towards the average of a central bank's repo-rate between the IMM-dates in the start and the end month of the series and calculated by the exchange or a fixing provider used by the exchange.

In this section, with regards to the examples, some specific terms and definitions are used, below follows a description of these.

The financial instrument may be a Futures contract with Daily Cash Settlement, wherein the Contract Base is a synthetic 3-month loan, with interest rate referring to the actual days between two IMM dates and cash settled against the average central bank repo rate for the specific period, expressed as compounded rate.

Contract Base Size is a nominal amount and may be one million Swedish kronor (for Sweden). However other currencies may be used and also other amounts depending on where the instrument will be traded.

The price of the Future contract is usually determined by the parties that are about to enter into the contract. Preferably the Future price shall be expressed as compounded repo rate associated with the specific repo rate periods. The price may be expressed with three decimals.

The tick size used when trading the contract according to the invention may be set to 0.001 or 0.01 or 0.1 and so forth. The tick value is preferably based on number of calendar days in the contract period and the contract base amount.

Daily Fix

During the Futures Contract's Term, Daily Fix shall preferably be determined based on information produced by a computerized Exchange in accordance with the following: For each Series of the contract in question, an average of the bid and ask prices published by each respective interbank trade may be calculated on the stated day. Preferably up-to-date quotations which include both bid and ask quotations is included in the calculation. The Daily Fix shall be the median value of the average prices calculated in accordance with the above. In the event that indicative bid and ask prices are not available the computerized Exchange may calculate Daily Fix by using other methods. The computerized Exchange shall notify Exchange Members and Clearing Members, on behalf of the member or customer, of the determined Daily Fix by for example sending computer messages.

Expiration Day Fix

The Expiration Day Fix of the contract shall normally be determined in accordance with the following. The Contract's final settlement price may in a preferred embodiment be calculated by the computerized Exchange on the Expiration Day and is equivalent to the compounded repo rate (central bank repo rate) between a second IMM date and the previous IMM date as described above.

Expiration Day

The Expiration Day is preferably two Bank Days prior to the third Wednesday of the Expiration Month. However it could also be one day prior or the same day as the end date of the specific period.

Expiration Month

Can be any month, however according to a preferred embodiment of the invention the following expiration months are used: Mars (“H”), June (“M”), September (“U”) and December (“Z”).

Expiration Year

The year listed in the Series designation. Thus an operator using the system and setting up a new series may select an expiration year. This can be any number of years in the future, however preferably it is selected to be between 1-10 years in the future. Shorter terms may also be used.

Final time for Registration

According to a preferred embodiment of the invention Application for Registration is received by the Exchange preferably not later than 19.15 CET on normal Bank Days and on the Expiration Day.

Daily Cash Settlement

In order to secure the fulfillment of the Futures Contract according to the invention, Daily Cash Settlement may take place every Bank Day from the transaction day until the Expiration Day for the Futures contracts in accordance with daily cash settlement of bond and index futures.

Settlement

Payment of Settlement may occur on the Final Settlement Day in accordance with the Exchange's instructions.

Final Settlement Day

Is usually the first Bank Day following the Expiration Day

Series Term

The series term according to a preferred embodiment of the invention is Twelve months. However other durations may be used such as 6 months, 18 months, 24 months or the alike depending on the context wherein the present invention is going to be used.

Setting-Off of Contracts

Setting-Off of Contracts may occur every Bank Day during the entire Term of the contract, where final settlement may occur in accordance with the following:

(i) when Setting-Off of an initially purchased Futures Contract, between the determined closing price for the Futures Contract on the previous Bank Day—or, if the purchase occurred on the same day as the following Registration of the counter Contract on the same account, the Futures Price for the counter Contract—and the Futures Price for the counter Contract, or

(ii) when Setting-Off of an initially sold Futures Contract, between the Futures Price for the counter Contract and the determined closing price for the Futures Contract on the previous Bank Day—or, if the sale occurred on the same day as Registration of the counter Contract on the same account, the Futures Price that the initial Futures Contract was sold for.

Market Model and Central Counterparty Clearing

The financial instrument according to the invention may be traded in the OTC market outside a computerized exchange or it can be traded by use of a computerized exchange.

In both cases the exchange preferably has agreements with a number of market makers regarding the maintenance of a market with two-way prices aimed at ensuring ample liquidity in the contract. Market makers are expected to establish indicative two-way prices in the exchange's computerized trading system in accordance with standard market practices in the fixed income market.

In the OTC market, the trading may be performed through a bilateral negotiation between a buyer and a seller. If the seller and buyer reach an agreement, (trade) a deal is created The deal is reported by sending deal messages to the computerized exchange system, such as NasdaqOMX exchange in Stockholm or New York for clearing. Novation, meaning when the exchange substitutes existing contracts with new ones, in relation to the buyer and seller takes place when the details of the deal are compared and collateral has been established. It is not necessary that there is a counterparty relationship between the buyer and seller; instead both parties to the trade may use the exchange or a clearing house as counterparty. In the case the deal message is sent to a exchange system, the exchange system may forward the deal message to a computerized clearing system according to the invention.

In the case the financial instrument according to the invention is traded at a computerized exchange the buyer and seller may send in orders in computer messages to the exchange. These orders preferably comprise an instrument value set by one of the parties, for a specific financial instrument series. When the order is received by the computerized exchange the computerized exchange system checks if the order can be matched directly with a counter order that is present in an orderbook. If no match is possible the order is stored in the orderbook which is a memory allocation in a computer readable memory, such as a cash memory or other working memory of the computerized exchange system.

In another embodiment the computerized exchanged may be configured to facilitate electronic negotiation. In this case a number of messages may be interchanged between the buyers trading terminal and the sellers trading terminal via the computerized exchange system.

Contract Base and Settlement Principles

The contract base that may be used is preferably a fictitious loan, which extends between two consecutive IMM dates, meaning between the third Wednesday in the months of e.g. March, June, September and December. Accordingly, the underlying duration can vary between series with different delivery months. Normally the period is 90 or 91 days, but may be longer or shorter. The term corresponds to the terms for NasdaqOMX Stockholms FRA contract, but the differences in the name standards and underlying interest-rate periods for each delivery month should be observed.

In a preferred embodiment there is no delivery of the underlying loan amount. Only a cash amount corresponding to the interest-rate difference between the agreed interest rate and the fixing rate may be paid. Accordingly, the contract can be considered a contract for difference (CFD). The buyer of the contract may be a fictitious borrower who assumes the obligation to pay the difference between the agreed interest rate and the fixing rate to the seller on condition that the agreed interest rate is higher. If the agreed interest rate is lower than the fixing rate, the buyer is paid the interest rate amount by the seller.

When the contract is cleared, no actual payment takes place between the buyer and seller; instead, each party receives/pays from/to the exchange acting as a clearing house or the clearing house.

Settlement and Offsetting

Preferably all purchased and sold contracts are entirely offsettable against each other. This means that only one net position is held against the clearing house and, if the contracts sold equal those purchased, the portfolio may be said to be closed in practice.

Daily cash settlements take place on bank days at noon and are based on the profit/loss on the net position at the end of the trading day on the bank day before the settlement day.

FIG. 7 is an example of a contract according to the invention wherein the repo sub-periods do not coincide with the start and end dates of the time period. Thus the sub-periods may be longer or shorter than 7 days depending on when the central banks decide to issue new repo rates. Usually these sub-periods extends from Wednesday to Wednesday, however when the central banks depart from this behavior the IMM dates may occur during a duration of a sub-period as illustrated in FIG. 7. If that is the case the calculation of the final fix may be executed by a computer as follows.

Calculation of final fix when the IMM date occurs during a sub-period associated with a repo rate.

((1+3/100*2/360)*(1+2/100*14/360)*((1+2/100*14/360)*(1+2/100*14/360)*(1+2/100*14/360)*(1+1/100*14/360)*(1+2/100*3/360)−1)*(360/91)*100=1,828%

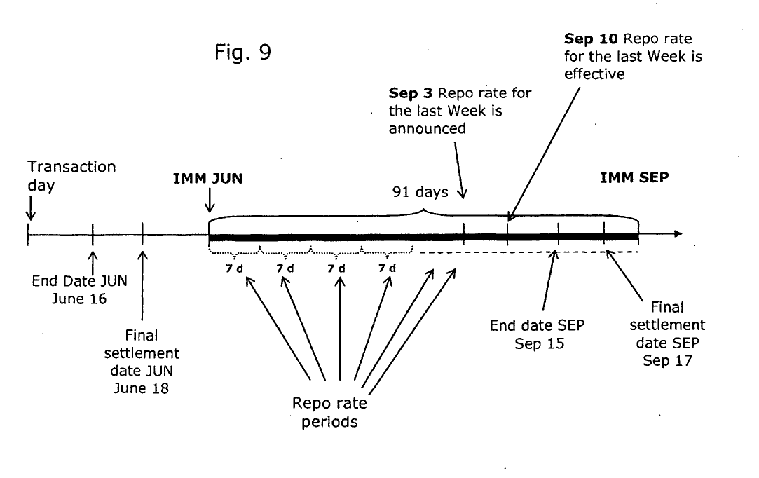

FIG. 9 illustrates another example for a contract wherein the end dates of the time period coincide with the end/start date of the sub-periods. The contract in FIG. 9 belongs to a series (RIBAU8) that have the following parameters that may be set by an operator upon creation of the contract in the computer system.
Contract name: RIBAU8
First trading day: Sep. 16, 2007
End day: Sep. 15, 2008
Final fix: Sep. 15, 2008
Final settlement day: Sep. 17, 2008
Term of contract base: 91 calendar days, Jun. 18, 2008-Sep. 17, 2008
Daily cash settlement: every bank day beginning Sep. 17, 2007
Collateral: Established daily at 11:00 a.m.

Collateral margins for the contract may be established continuously during the term of the contract as will be described in the Margining section.

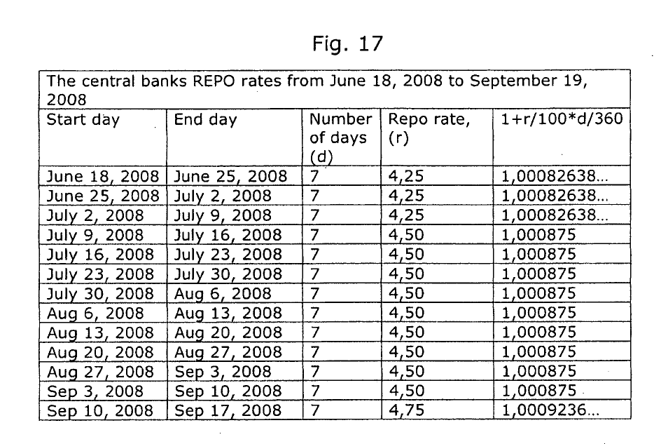

With regards to the calculation of the final fixing of RIBA U8 in the example above, the central bank repo rates shown in FIG. 17 are used.

Final fix corresponds to the average repo rate during the term of the contract, expressed as compound interest. In this case, there are 13 sub-periods each associated with a specific repo rate. The time period comprising these sub-periods comprises a total of 91 calendar days between the start date and end date.

The compounded interest, expressed to three decimal places, for the interest period between Jun. 18, 2008 and Sep. 17, 2008 thus equals 4.485%.

((1,000826389 . . . )*(1,000826389 . . . )*(1,000826389 . . . )*(1,000875)*(1,000875)*(1,000875)*(1,000875)*(1,000875)*(1,000875)*(1,000875)*(1,000875) *(1,000875)*(1,0009236 . . . )−1)*(360/91)*100=4,485

Example of Final Settlement for RIBA U8

The final settlement may take place one bank day before the third Wednesday of the end month, according to IMM. For the contract RIBA U8 in this example, final settlement takes place on Tuesday, September 16 and is based on the difference between the final fix calculated on Monday, September 15, and the last daily fixing calculated on Friday, September 12. In this example, we have assumed that the daily fixing rate on September 12 was 4.480% and that we have purchased position of 10,000 contracts.

Number of Purchased Contracts*Nominal Amount*(Final Fix-Daily Fix)/100*d/360

10000*1000000*(4,485−4,480)/100*91/360=126,38889 (rounded to 126,389)

Example of Daily Fix Calculation for RIBA U8

The daily fix is calculated as the median value of the indicative buy and sell interest rates that market makers, among others, quote in the computerized exchange system on bank days at a certain time, for example 4:15 p.m. In the table below market makers A-E have sent in a number of quotes or orders having a bid and/or ask price as shown in the bid and ask column. As can be seen from the table the daily fix is 4,480.

| Market maker | Bid | ASK | Average |
|---|---|---|---|
| A | 4,475 | 4,495 | 4,485 |
| B | 4,485 | 4,505 | 4,495 |
| C | 4,465 | 4,485 | 4,475 |
| D | 4,470 | 4,490 | 4,480 |
| E | 4,470 | 4,490 | 4,480 |
| Median | | | 4,480 |

Computerized exchange systems comprise orderbooks that are memory allocations for contracts belonging to a specific series. These computerized exchange system disseminate information flows to the members connected to the system in order to update them with the latest changes made in the orderbook. Thus the computer system according to the invention may listen to one or more of these information flows, for example the market data message flow. In this way real time information can be provided such that daily fix or final fix can be calculated any time during the day.

Margining

The following section will describe some of the theory and a few examples of margining calculations for the instrument according to the invention.

First Some Definition Used in the Examples:

t=Day

IMM=Number of days in IMM period

d=Number of days in year

N=Nominal value

C=Number of contracts

Par=Risk interval parameter

Y=Yield (contracted)

Fix(t)=Fixing yield at day t

Adj=Adjustment factor for bought/sold contracts

Open Margin

The following formulas are used when calculating the Open margin.

Preferably a position's open margin, also referred to as initial margin, shall cover market movements for two days. The naked open margin is the open margin if there are no correlated contracts in the portfolio.

In an embodiment of the invention the naked open margin is calculated according to equation 1 and equation 2 below.

Bought Contracts

Naked open margin=[((Fix(t)−Par)−Fix(t)−Adj)*IMM/d*N]₂*C (1)

Sold Contracts

Naked open margin=[(Fix(t)−(Fix(t)+Par)−Adj)*IMM/d*N]₂*C (2)

In the equations above, the “[ . . . ]₂” means that it is rounded to two decimals Furthermore the margining system, RIVA, creates in a memory allocation a vector file containing 201 nodes and the fixing yield will scan between Fix(t)±Par evenly distributed over the 201 nodes. In each node an open margin will be calculated according to the above formulas except that Fix(t)+Par will be changed to the node's corresponding value of the fixing yield. RIVA will choose the open margin from the node that corresponds to the worst value for the whole portfolio.

Payment Margin

A position's payment margin represents the position's profit and loss and it is preferably calculated according to equation 3 and equation 4, as follows:

Bought Contracts

Payment margin=(Fix(t)−Fix(t−1))*IMM/d*N*C (3)

Sold Contracts

Payment margin=(Fix(t−1)Fix(t))*IMM/d*N*C (4)

For positions that were bought/sold on day t the contracted yield is used instead of Fix(t−1) in the above formulas (3) and (4).

Based on the above equations (1)-(4) a number of examples will hereby be presented. These examples should be understood that they are implemented on computerized systems comprising one or more computer processors and relating computer means such as memories (primary, secondary), busses, registers, I/O devices and so forth.

### EXAMPLE 1

Part one

Consider a portfolio of 1 000 bought RIBAU9 contracts, wherein:

t=Aug. 4, 2009

IMM=91

d=360

N=SEK 1 000 000

C=1 000

Par=50 basis points

Y=4,40%

Fix(t)=4,35%

Adj=0,015%

Open Margin

Since the portfolio in this example only contains RIBAU9 contracts the open margin is equal to the naked open margin calculated according to equation (1).

Open margin=[((0,0435−0,0050)−0,0435−0,00015)*91/360*1000000]₂*1000=−1301810.

Payment Margin

The payment margin equals the position's profit and loss and it is calculated according to equation (3).

Payment margin=(0,0435−0,0440)*91/360*1000000*1000=126389.

Margin Requirement

The margin requirement is equal to the payment margin plus the open margin.

Margin requirement=payment margin+open margin=−1428199.

Part Two

Consider the same portfolio as in part one. Suppose the RIBAU9 contracts are closed out on Aug. 5, 2009 at a yield of 4,40%.

t=Aug. 5, 2009

t−1=Aug. 5, 2009

IMM=91

d=360

N=SEK 1 000 000

C=1 000

Par=50 basis points

Y=4,40%

Fix(t)=4,45%

Fix(t−1)=4,35%

Adj=0,015%

Open Margin

In this case there will be no open margin since there are no open positions in the portfolio.

Payment Margin

The payment margin equals the closed in profit and loss.

Payment margin=(0,0440−0,0435)*91/360*1000000*1000=126389.

Margin Requirement

The margin requirement is equal to the payment margin plus the open margin.

Margin requirement=payment margin+open margin=SEK 126 389.

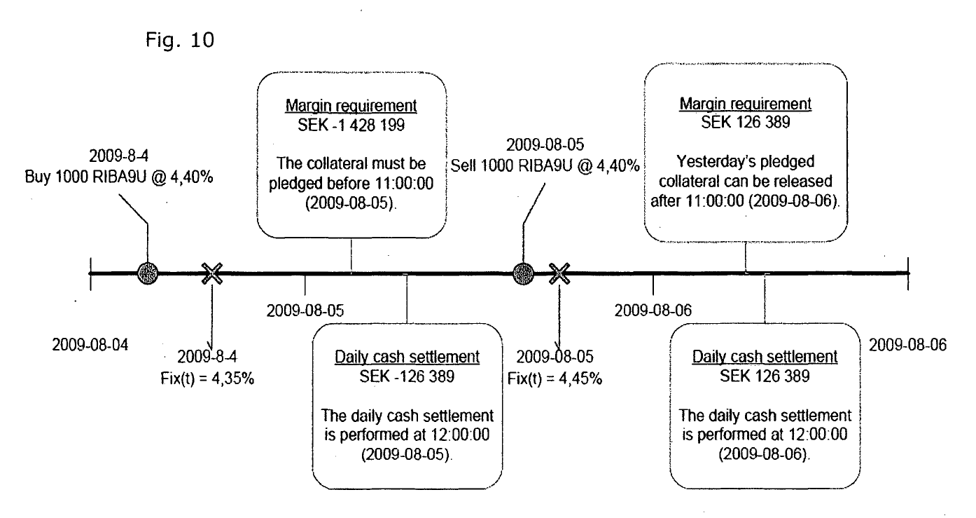

FIG. 10 illustrate the payment flows according to example 1 of the margin payments.

### EXAMPLE 2

Consider a portfolio consisting of 1 000 bought contracts of RIBAU9 at a contracted yield of 4,40% and 700 sold contracts of RIBAX9 at a contracted yield of 4,05%.

| RIBAU9 (bought) | RIBAX9 (sold) |
|---|---|
| t = 2009-09-03 | t = 2009-09-03 |
| IMM = 91 | IMM = 91 |
| d = 360 | d = 360 |
| N = SEK 1 000 000 | N = SEK 1 000 000 |
| C = 1 000 | C = 700 |
| Par = 50 basis points | Par = 50 basis points |
| Y = 4.40% | Y = 4.05% |
| Fix(t) = 4.35% | Fix(t) = 4.00% |
| Adj = 0.015% | Adj = 0.015% |

Margin Calculations

Open Margin

Two vector files will be created as shown in FIG. 16, one for RIBAU9 and one for RIBAX9. Each vector file contains 201 nodes and in each node an open margin will be calculated according to equation (1) and equation (2).

In this example RIBAU9 and RIBAX9 are considered to be 63% correlated and therefore their window size is set to 370%. This means that the open margin for the two contracts must be selected from nodes that are within a 75 nodes distance (37% of 201 nodes which must be an odd number). In this example the worst margin for RIBAU9 is at node 201 and this is also the worst margin for the complete portfolio. The system will start at node 201 and look 75 nodes up and chose the worst margin for RIBAX9 within these nodes.

RIBAU9

The fixing yield of node 201 is used.

Open margin=[(0,0385−0,0435−0,00015)*91/360*1000000]₂*1000=−1301810.

RIBAX9

The fixing yield of node 127 is used.

Open margin=[(0,0400−0,0387−0,00015)*91/360*1000000]₂*700=203483.

Payment Margin

RIBAU9

The payment margin equals the position's profit and loss and it is calculated according to equation (3).

Payment margin=(0,0435−0,0440)*91/360*1000000*1000=−126389.

RIBAX9

The payment margin equals the position's profit and loss and it is calculated according to equation (4).

Payment margin=(0,0405−0,0400)*91/360*1000000*700=88472.

Margin Requirement

The margin requirement equals the payment margin plus the open margin for the two positions.

RIBAU9

Total margin=payment margin+open margin=−1428199.

RIBAX9

Total margin=payment margin+open margin=291955.

Margin Requirement

Margin requirement=Total margin RIBAU9+Total margin RIBAX9=−1136244.

### EXAMPLE 3

Consider a portfolio consisting of 1000 bought contracts of RIBAX9 at a contracted yield of 4,40% and 1000 sold contracts of FRA09U at a contracted yield of 4,75%.

| RIBAX9 (bought) | FRA09U (sold) |
|---|---|
| t = 2009-09-03 | t = 2009-09-03 |
| IMM = 91 | IMM = 91 |
| d = 360 | d = 360 |
| N = SEK 1 000 000 | N = SEK 1 000 000 |
| C = 1 000 | C = 1 000 |
| Par = 50 basis points | Par = 40 basis points |
| Y = 4.40% | Y = 4.75% |
| Fix(t) = 4.35% | Fix(t) = 4.70% |
| Adj = 0.015% | |

Margin Calculations

Open Margin

The open margin for a sold FRA contract is calculated according to equation (5).

Open margin=(Y*IMM/d*N−[(Fix(t)*1,001+Fixnode−Fix(t))*IMM/d*N]₀)*C (5)

In the equation (5) above, the “[ . . . ]₀” means rounding to zero decimals.

Two vector files will be created, one for RIBAX9 and one for FRA09U. Each vector file contains 201 nodes and in each node an open margin will be calculated according to equation (2) and equation (5). In this example RIBAX9 and FRA09U are considered to be 90% correlated. This means that their open margin must be chosen within a 21 nodes distance. A similar analysis as in Example 2 shows that node 201 and node 182 will be used.

RIBAX9

The fixing yield of node 201 is used.

Open margin=[(0,0385−0,0435−0,00015)*91/360*1000000]₂*1000=−1 301 810.

FRA09X

The fixing yield of node 182 is used. This equals 4,376%.

Open margin=(0,0475*91/360*1000000−[(0,0470*1,001+0,04376−0,0470)*91/360*1000000)]₀)*1000=993944.

Payment Margin

RIBAX9

The payment margin equals the position's profit and loss and it is calculated according to equation (3).

Payment margin=(0,0435−0,0440)*91/360*1000000*1000=−126389.

Margin Requirement

RIBAX9

Total margin=payment margin+open margin=SEK−1 428 199.

FRA09U

Total margin=open margin=SEK 933 944.

Margin Requirement

Margin requirement=Total margin RIBAU9+Total margin FRA09X=−494254.

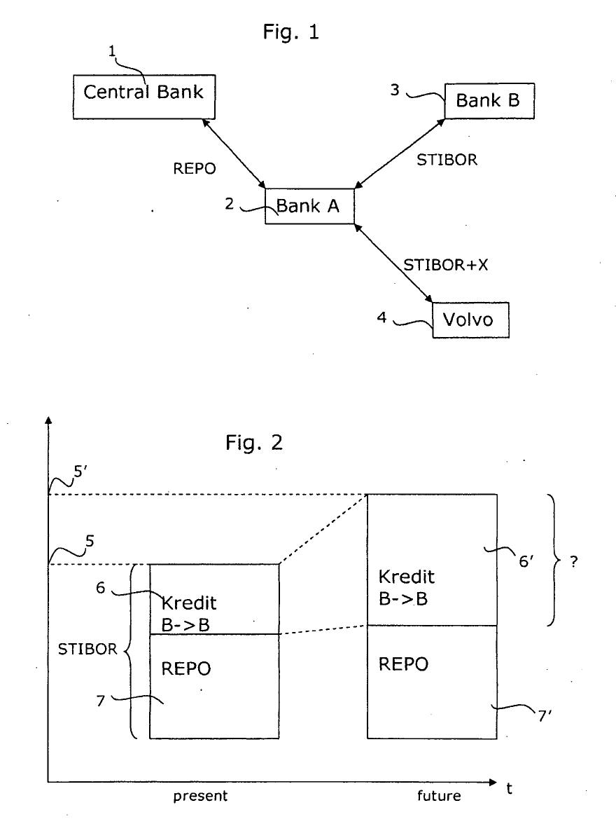

FIG. 1 illustrates an interbank market comprising a central bank 1, a first bank 2, a second bank 3 and a private company 4. These players each have their different needs and risk exposure. Since the central bank 3 is supported by a government it is considered to be a very secure player with regards to risk. The central bank sets the REPO rate which is the rate of interest at which banks can borrow or deposit funds at the central bank for a period of seven days. STIBOR is a reference interest rate usually used between two banks, STIBOR stands for Stockholm Interbank Offered Rate. LIBOR is a similar interest rate used between banks and stands for London Interbank Offered Rate. These two interest rates may be used as daily reference interest rates when pricing derivatives contracts. Other similar interest rates exist in other parts of the world, thus the present invention is not only limited to the use of STIBOR or LIBOR. When a bank 2, 3 will lend money to a company 4 such as volvo, the bank will add a “fixing” on top of the STIBOR or LIBOR interest rate because of the credit risk.

FIG. 5 illustrates how these interest rates are built up, with the REPO 7 in the bottom which is the central banks interest rate as explained above. Adding a credit risk cost 6 to the repo makes the STIBOR interest rate. This is equal to the STIBOR fixing 5 which is the credit risk cost for lending money from a bank to a company, as illustrated in FIG. 4.

Over time, each of the elements 5, 6, 7 in FIG. 5 may change to 5′, 6′, 7′, due to for example political, economical disturbance. When such disturbance occurs it may lead to higher interbank interest rates. When such disturbances lead to an abnormal increase in the interbank rates this may cause problems with regards to profitability for some players such as banks. By use of the present invention 7′ can be obtained. 5′ is for example the FRA fix, thereby 6′ can be calculated.

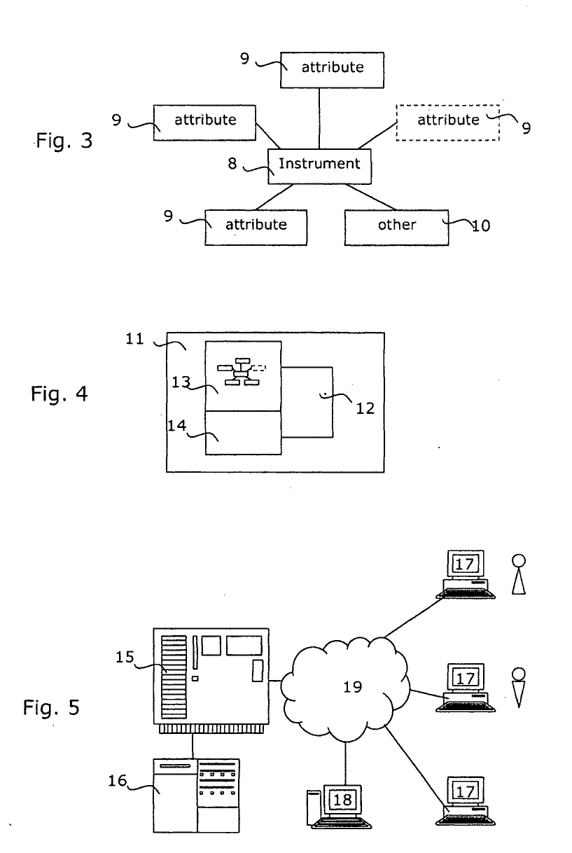

FIG. 3 illustrates a financial instrument according to a preferred embodiment of the invention. The instrument is illustrated as an instrument 8 comprising a number of attributes 9 and possibly also some other type of attributes 10 associated with the instrument. The attributes 9 is preferably attributes defining the time period, attributes defining the sub-periods, attributes defining the nominal amount to be used as a base, attributes defining a settlement method, the attributes may also define: contract type, contract base size, future price, tick size, daily fix, expiration day fix, expiration day, expiration month, final time for registration, daily cash settlement, final settlement day, series term, setting-off of contracts, listing, listing of series, series designation and so forth.

FIG. 4 illustrates a computer device 11 comprising a memory 13 such as a primary storage, an I/O interface 14 and a Central Processing Unit (CPU) 12 for managing the instrument stored in the memory according to software instructions that have been downloaded into the memory 13. The computer device in FIG. 4 may be part of a computer system such that it is connectable to a hard disk (not shown), a communication interface (not shown), a monitor (not shown), a mouse (not shown), a printer (not shown) and so forth. The management of the instrument is preferably performed by the CPU 12, and the memory 13 is configured to store the programs instructions and data such that the CPU 12 can access the data and instructions. A bus (not shown) may be used in order to interconnect all the hardware devices such that the devices are able to communicate with each other.

The computer device 11 in FIG. 4 may be used in any type of computer such as a terminal computer or a server computer.

FIG. 5 illustrates a computerized central exchange system 15, connected to a plurality of external trading terminals 17, 18 via a network 19. The computerized central exchange system 15 further being connected to a computerized clearing system 16.

Preferably the users at the external trading terminals 17 creates orders for the instrument they want to trade and then sends their order by use of the external trading terminals 17. The external trading terminals sends an order message via the network 19 to the computerized central exchange system 15 that receives the order message and tries to match the order with a counter order if possible. If the order is not matched when received at the computerized central exchange 15 the order will be stored in an orderbook that is a part of the memory of the computerized central exchange system 15. The order messages may be sent by use of FIX standards or any other suitable protocol that makes it possible for the computer devices to communicate with each other.

Furthermore an algorithmic external trading machine 18 may be used for creating and sending in orders to the computerized central exchange 15. This type of machine is much faster compared to a human trader. The trading machine 18 may receive message flows such as Market By Order (MBO) flow, Market By Price (MBP) flow and so forth, these may be referred to as market data feed. Based on the information received the trading machine is programmed to execute one or more algorithms depending on the received information. In this way a much faster reaction can be achieved when the market changes due to some reason such as political, economical or other reason that can have an impact on the prices of the instruments traded.

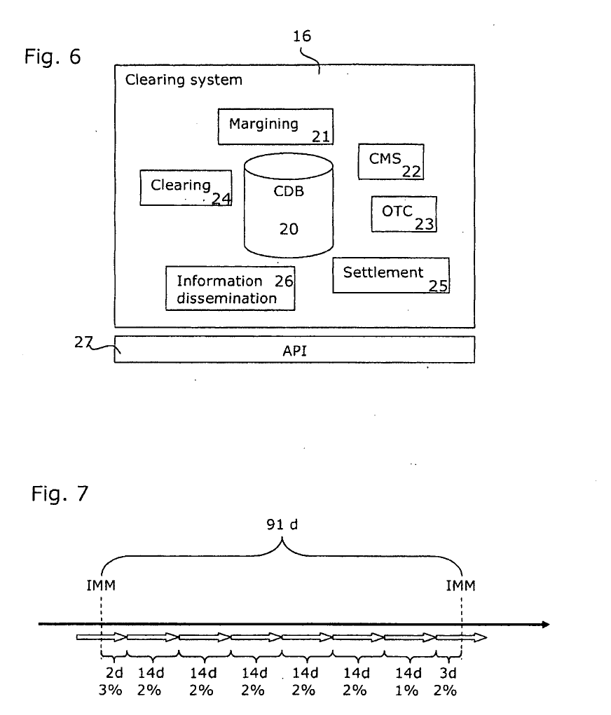

FIG. 6 illustrates a computerized clearing system 15, the clearing system comprising a central data base (CDB) 20, a margining module 21 for managing margin, a centralized multilateral clearing of standardized exchange-traded products (CMS) module 22, a tailor made clearing for the OTC market module (TM OTC) 23, a clearing module 24, a settlement module 25, and an information dissemination module 26. The computerized clearing system gives full support for clearing administration task such as amendments, allocations, give-ups, commissions, exercises, transfers and so forth. Since the computerized clearing system 20 has an open API 27, clearing members can connect their own back-office applications or a third party application to the computerized clearing system thereby the clearing members can handle administration online. An example of a clearing system that may be used in relation with the present invention is the SECUR clearing system or GENIUM clearing system provided by NasdaqOMX.

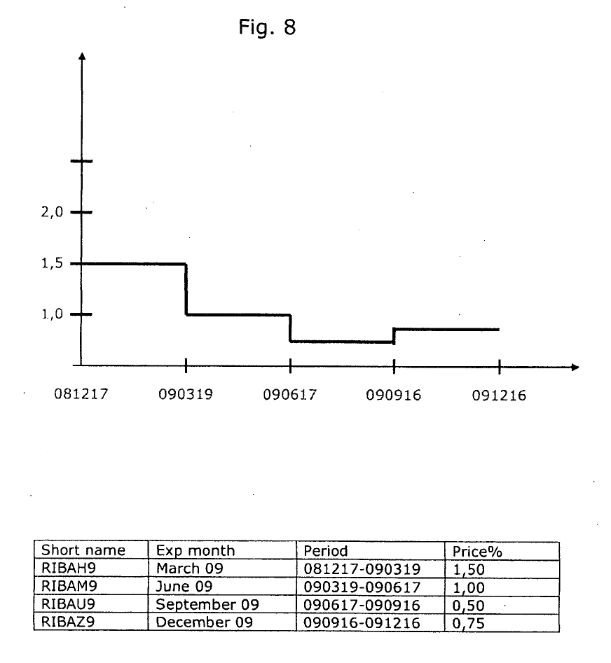

FIG. 8 discloses a graphical product (RIBA graph) than can be sold to parties wishing to see how the price has changed over time for a contract according to the invention. The graph may be published on a web page such as the NasdaqOMX web site. Furthermore it can be distributed as a graphical product in the market data feed. The graph is preferably based on data for each individual contract in the market data feed. Furthermore it may be based on a live feed and/or based on end of day fixing data.

Preferably the chart is created by a computer that receives information sent from a trading system wherein instruments according to the present invention are traded.

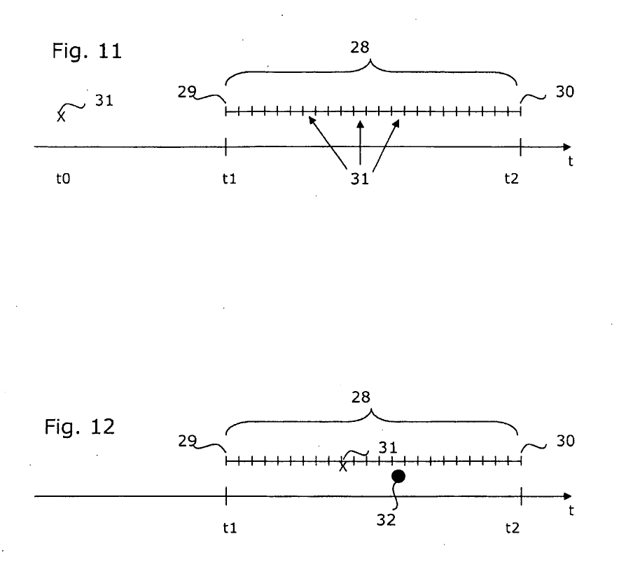

FIG. 11 illustrates an example of an instrument according to the invention comprising a time period 28 having a start time 29 and an end time 30.

Furthermore the time period 28 comprises on or more sub periods 31, each sub period is associated with a central bank interest rate. Furthermore an acceptance date 31 is disclosed. At the acceptance data a buyer and a seller agrees to enter into the contract according to the invention.

FIG. 12 illustrates another embodiment wherein the acceptance date 31 is within the time period 28. According to this embodiment the computer system may create a decision point 32 between the start time 29 and the end time 30 of the time period 28. Preferably the final value of the contract is calculated after the decision point 32. The decision point can be determined when the computer system have received enough information about the central bank interest rate associated with the sub-periods such that a final value can be calculated. Thus the decision point 32 can be located anywhere between the start time 29 and the end time 30 of the time period 28. Preferably the acceptance date may not occur after the decision point 32. However the acceptance date may occur after the decision point 32 if the final value have not been calculated.

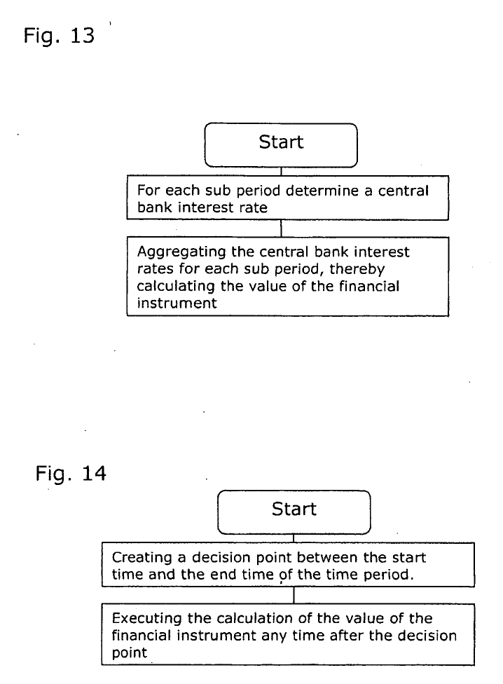

FIG. 13 illustrates a flow chart for a method according to the invention wherein the method for each sub period determines a central bank interest rate. For example the interest rate can be feed to the computer system as mentioned above, or provided to the computer system by other pull or push technologies.

FIG. 14 illustrates a flowchart for a method according to the invention for creating a decision point between the start time 29 and the end time 30 of the time period 28.

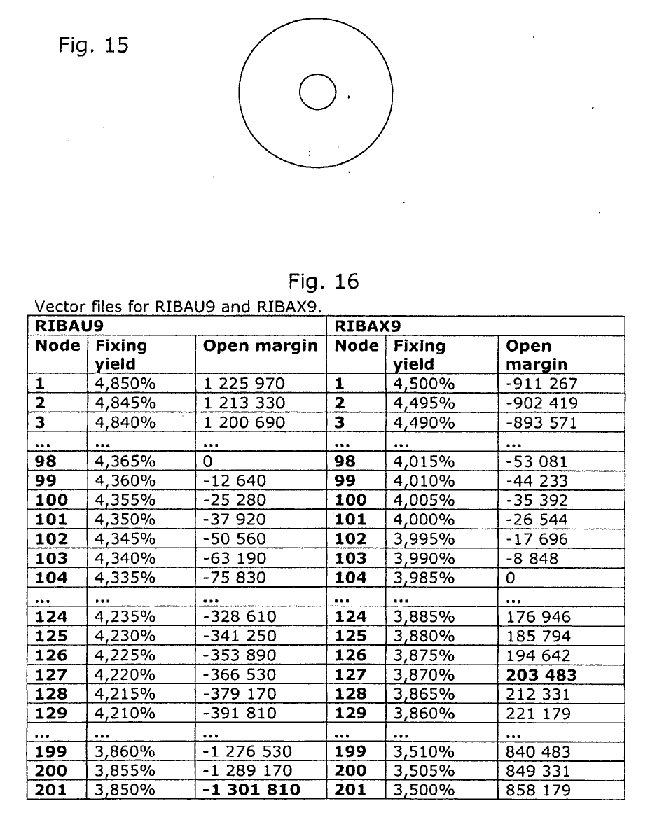

FIG. 15 illustrates a computer readable medium comprising program instruction according to the invention. The computer readable medium may also comprise a USB memory or the alike. It may also be replaced with a computer network for transferring the programs instructions over the network.

In the above description the term “comprising” does not exclude other elements or steps and “a” or “an” does not exclude a plurality.

Furthermore the terms “include” and “contain” does not exclude other elements or steps.

1. A financial instrument stored in a memory of a computer system, the financial instrument comprising:
attributes defining a time period comprising a start time and an end time, and
attributes defining one or more sub periods between the start time and the end time of the time period,
wherein a final value of the financial instrument is based on an aggregation of central bank interest rates associated with one or more of the one or more sub periods.

2. A financial instrument according to claim 1 wherein the final value is calculated in accordance with:
$$( ( {\prod }_{k = 1}^{n} 1 + \frac{{r}_{k}}{100} * \frac{{d}_{k}}{360} ) - 1 ) * \frac{360}{cd} * 100$$
Where:
r is the central bank interest rate for a specific sub period (k),
d is the number of days for a specific sub period (k),
k is the number of sub periods,
cd is the number of days between the start time and the end time of the time period.

3. A financial instrument according to claim 1, wherein the financial instrument further comprises attributes defining a nominal amount to be used as a base for the financial instrument.

4. A financial instrument according to claim 1, wherein the financial instrument further comprises attributes defining a settlement method.

5. A financial instrument according to claim 4, wherein the settlement method comprises daily cash settlement.

6. A financial instrument according to claim 1, further comprising an acceptance date for accepting the financial instrument prior to the end time of the time period.

7. A financial instrument according to claim 1, wherein the sub periods comprise any number of days between 1-98 days.

8. A financial instrument according to claim 1, wherein the start date and the end date of the time period are IMM dates.

9. A financial instrument according to claim 1, wherein the financial instrument is a futures contract.

10. A computerised method implemented on a computer for calculating a value of a financial instrument stored in a memory of the computer, the financial instrument comprising: attributes defining a time period comprising a start time and an end time, attributes defining one or more sub periods between the start time and the end time of the time period, the method comprising the steps of:
for each sub period, determining a central bank interest rate,
aggregating the central bank interest rates for each sub period,
thereby calculating the value of the financial instrument.

11. A computerised method according to claim 10, wherein the final value is calculated in accordance with:
$$( ( {\prod }_{k = 1}^{n} 1 + \frac{{r}_{k}}{100} * \frac{{d}_{k}}{360} ) - 1 ) * \frac{360}{cd} * 100$$
Where:
r is the central bank interest rate for a specific sub period (k),
d is the number of days for a specific sub period (k),
k is the number of sub periods,
cd is the number of days between the start time and the end time of the time period.

12. A computerised method according to claim 10, further comprising the steps of:
creating a decision point between the start time and the end time of the time period, and
executing the calculation of the value at the decision point or any time after the decision point.

13. A computerised method according to claim 12, wherein central bank interest rates associated with the sub periods before and after the decision point is used in the calculation of the value.

14. A computerised exchange system for matching orders for financial instruments sent from trading terminals, the financial instrument comprising attributes defining a time period comprising a start time and an end time, and attributes defining one or more sub periods between the start time and the end time of the time period, the computer system comprising:
an input module for receiving a buy order for the financial instrument from a first party, and for receiving a sell order for the financial instrument from a second party, the buy and sell order comprising at least an instrument value set by the parties,
a matching module associated with the input module for matching the buy order with the sell order for the financial instrument based on the instrument values,
thereby creating a deal.

15. A computerised exchange system according to claim 14, wherein the instrument values comprises an index price value or an interest rate value.

16. A computerised exchange system according to claim 14, further comprising an information dissemination module for reporting the deal in the matching module to a computerised clearing system by sending a deal message.

17. A computerised exchange system according to claim 14, wherein the buy order further comprises a configurable first date and a configurable second date for defining a time period for the instrument in the buy order.

18. A computerised exchange system according to 14, wherein the sell order further comprises a configurable first date and a configurable second date for defining a time period for the instrument in the sell order.

19. A computerised exchange system according to claim 14, further comprising a link connectable to a bank for receiving input regarding interest rates.

20. A computerised clearing system for clearing of financial instruments comprising attributes defining a time period comprising a start time and an end time, and attributes defining one or more sub periods between the start time and the end time of the time period, the computerised clearing system is configured to receive daily fixing values, the computerised clearing system comprising:
a first memory allocation comprising an account comprising positions associated with the financial instruments for an account holder,
a second memory allocation for storing daily fixing values received by the computerised clearing system, and
a settlement module for performing settlements of the accounts,
wherein the computerised clearing system comprises instructions that when executed by a processor performs daily settlements for one or more accounts based on the daily fixing value stored in the second memory allocation.

21. A computerised clearing system according to claim 20, wherein the computerised clearing system further comprises instructions that when executed by the processor calculates the daily fixing value based on a midprice in an order driven market.

22. A computerised clearing system according to claim 20, further comprising a margin module for calculating margin associated with the account.

23. A computerised clearing system according to claim 20, further comprising a mark to market module for determining a market value for a position in the account.

24. A computerised clearing system according to claim 20, further comprising a calculation module for calculating collateral associated with the account.

25. A computer readable medium comprising program instructions for execution on a computer system that, when executed by a processor, cause the processor to match financial instrument comprising attributes defining a time period between a first point in time and a second point in time, and attributes defining a plurality of sub periods within the time period, wherein a final value of the financial instrument is based on an aggregation of central bank interest rates associated with the sub periods.

26. A computer readable medium comprising program instructions for execution on a computer system that, when executed by a processor, cause the processor to clear financial instrument comprising attributes defining a time period between a first point in time and a second point in time, and attributes defining a plurality of sub periods within the time period, wherein a final value of the financial instrument is based on an aggregation of central bank interest rates associated with the sub periods.

27. A computer program product comprising a market data, the market data comprising data associated with the financial instrument according to claim 1.
